(19) United States
(12) Patent Application Publication
(10) Pub. No.: US 2018/0307079 A1
(43) Pub. Date: Oct. 25, 2018

(54) LIQUID CRYSTAL DISPLAY PANEL AND LIQUID CRYSTAL DISPLAY APPARATUS USING SAME

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/561,750

(22) PCT Filed: Aug. 15, 2017
(86) PCT No.: PCT/CN2017/097494

§ 371 Date: Sep. 26, 2017

(30) Foreign Application Priority Data
Apr. 24, 2017 (CN) 201710272091.8

(51) Int. Cl. G02F 1/1343; G02F 1/1335; G02F 1/1362; G02F 1/1339; G02F 1/1368

(52) U.S. Cl. CPC G02F 1/13439; G02F 1/133512; G02F 1/133514; G02F 2001/133388; G02F 1/13394; G02F 1/1368; G02F 2001/136222; G02F 1/136286

(57) ABSTRACT

This application provides a liquid crystal display panel and a liquid crystal display apparatus using same. The liquid crystal display panel includes a first substrate and a second substrate. A common electrode is disposed on an inner side of the first substrate. A black matrix and a photo spacer are integrally formed on the common electrode by using a same material. A transfer pad is disposed on an inner side of the second substrate. A light shielding layer corresponding to the transfer pad has a hollow structure. A signal line is disposed on the inner side of the second substrate as an electrode contact to be connected to the transfer pad. A layout shape of the signal line is in a complementary relationship with a layout shape, in a part of a bezel region, of the light shielding layer.

### BACKGROUND

### Technical Field

This application relates to a liquid crystal display panel and a liquid crystal display apparatus using same, and in particular, to a process design of applying a light shielding layer (a black matrix (BM) and a photo spacer (PS)) to a color filter on array (COA).

### Related Art

A thin film transistor-liquid crystal display (TFT-LCD) is formed of a color filter (CF) substrate, a thin film transistor (TFT) substrate, a liquid crystal (LC) sandwiched between the CF substrate and the TFT substrate, and a sealant.

The TFT-LCD has two display modes: in plane switch (IPS) and vertical alignment (VA). In the IPS mode, LCs are horizontally aligned, and LC molecules in a parallel state are rotated so as to display an image during work. In the VA mode, LCs are vertically aligned, and LC molecules are perpendicular to two substrates of the screen when no power is applied, and the LC molecules fall down to form an angle relative to the substrates when power is applied.

Currently, a COA technology has become the mainstream of technologies developed by various manufacturers, with advantages of a high penetration rate and low costs. As a continuation of the COA design, some manufactures have developed a material integrating a BM and a PS to reduce process costs. However, the material has an optical density value, and light on some parts needs to be shielded by stacking color resists.

However, when the light shielding layer is applied to a liquid crystal display panel product in a VA mode using the COA technology, there are still some problems to be overcome. A common electrode signal of a liquid crystal cell in a VA mode usually needs to be conducted from a second substrate to a common electrode of a first substrate by using a transfer pad. However, to apply the light shielding layer, the common electrode needs to be disposed before the light shielding layer. Therefore, there is a risk of incomplete curing of a sealant on the transfer pad, and consequently, the common electrode of the first substrate cannot be conducted with the transparent electrode of the second substrate by using indium tin oxide.

### SUMMARY

To resolve the foregoing technical problems, the technical solution used in this application is: a liquid crystal display panel, comprising:

a first substrate, comprising a common electrode and a light shielding layer, where the light shielding layer is formed on the common electrode and is located on a bezel region of the first substrate, and the light shielding layer comprises an opening to expose the common electrode;

a second substrate, disposed opposite to the first substrate, where the second substrate comprises a plurality of active switches, a plurality of color resists, a transparent electrode, and a signal line, the plurality of color resists is formed on the active switches, the transparent electrode is formed on the plurality of color resists and is electrically connected to the active switches, the signal line and some of the plurality of color resists are located on a bezel region of the second substrate, and the color resists located on the bezel region of the second substrate comprise through holes to expose the signal line, so that the transparent electrode comes into contact with the signal line;

a liquid crystal layer, sandwiched between the first substrate and the second substrate; and

a sealant, formed on the bezel region and used to stick the first substrate with the second substrate in a sealing manner, where the sealant comprises a conductive metal ball to connect the common electrode of the first substrate to the transparent electrode of the second substrate, where

the signal line comprises a hollow structure, and a layout shape of the signal line is in a complementary relationship with an opening layout shape, in a part of the bezel region, of the light shielding layer.

In an embodiment of this application, a ratio of a light permeable area to a light shielding area of the light shielding layer corresponding to a transfer pad is in a range of 0.5 to 1.5.

In an embodiment of this application, the light shielding layer is in a central annular structure.

In an embodiment of this application, the light shielding layer is in a mesh structure.

In an embodiment of this application, the light shielding layer is in a fan-shaped structure.

In an embodiment of this application, the light shielding layer is in a staggered checkerboard structure.

In an embodiment of this application, the light shielding layer is in a staggered zigzag structure.

In an embodiment of this application, the light shielding layer is in a circular mesh structure.

In an embodiment of this application, the signal line is disposed in a part of the bezel region on an inner side of the second substrate as an electrode contact to be connected to the transfer pad thereabove.

In an embodiment of this application, the signal line has a hollow structure. A layout shape of the signal line is in a complementary relationship with a layout shape, in the part of the bezel region, of the light shielding layer. The signal line comprises a blue resist, a red resist, or a stack of a blue resist and a red resist.

In an embodiment of this application, a ratio of a light permeable area to a light shielding area of the signal line is in a range of 0.5 to 1.5.

This application further provides a liquid crystal display apparatus. In addition to a backlight module, the liquid crystal display apparatus further comprises the liquid crystal display panel according to the foregoing technical solution.

In an embodiment of this application, the light shielding layer located on the first substrate is in a hollow structure, and a ratio of a light permeable area to a light shielding area of the light shielding layer is in a range of 0.5 to 1.5.

In an embodiment of this application, the light shielding layer is in a central annular structure.

In an embodiment of this application, the light shielding layer is in a mesh structure or a fan-shaped structure.

In an embodiment of this application, the light shielding layer is in a staggered checkerboard structure.

In an embodiment of this application, the light shielding layer is in a staggered zigzag structure.

In an embodiment of this application, the light shielding layer is in a circular mesh structure.

In an embodiment of this application, the signal line comprises a blue resist, a red resist, or a stack of a blue resist and a red resist.

In an embodiment of this application, a ratio of a light permeable area to a light shielding area of the signal line is in a range of 0.5 to 1.5.

To resolve the foregoing technical problems, another technical solution used in this application is a method for manufacturing a liquid crystal display panel, comprising the following steps:

providing a first substrate and a second substrate;

forming a liquid crystal layer between the first substrate and the second substrate;

laying a common electrode on an inner side of the first substrate; and

integrally forming a BM and a PS on the first substrate by using a same material by means of a same process, where the light shielding layer is located below the common electrode.

In an embodiment of this application, the light shielding layer corresponding to a transfer pad is in a hollow structure. Further, a ratio of a light permeable area to a light shielding area of the light shielding layer corresponding to the transfer pad is in a range of 0.5 to 1.5.

In an embodiment of this application, the method for manufacturing a liquid crystal display panel further comprises the following steps:

disposing a signal line in a part of a bezel region on an inner side of the second substrate as an electrode contact to be connected to the transfer pad; and

disposing a blue resist, a red resist, or a stack of a blue resist and a red resist on the signal line.

In an embodiment of this application, the signal line has a hollow structure, and a layout shape of the signal line is in a complementary relationship with a layout shape, in a part of a bezel region, of the light shielding layer.

This application provides another liquid crystal display panel, comprising:

a first substrate, comprising a common electrode and a light shielding layer, where the light shielding layer is formed on the common electrode and is located on a bezel region of the first substrate, and the light shielding layer comprises an opening to expose the common electrode;

a second substrate, disposed opposite to the first substrate, where the second substrate comprises a plurality of active switches, a plurality of color resists, a transparent electrode, and a signal line, the plurality of color resists is formed on the active switches, the transparent electrode is formed on the plurality of color resists and is electrically connected to the active switches, the signal line and some of the plurality of color resists are located on a bezel region of the second substrate, and the color resists located on the bezel region of the second substrate comprise through holes to expose the signal line, so that the transparent electrode comes into contact with the signal line;

a liquid crystal layer, sandwiched between the first substrate and the second substrate; and

a sealant, formed on the bezel region and used to stick the first substrate with the second substrate in a sealing manner, where the sealant comprises a conductive metal ball to connect the common electrode of the first substrate to the transparent electrode of the second substrate, where

the signal line comprises a hollow structure, and a layout shape of the signal line is in a complementary relationship with an opening layout shape, in a part of the bezel region, of the light shielding layer; and

the light shielding layer located on the first substrate is in a hollow structure, a ratio of a light permeable area to a light shielding area of the light shielding layer is in a range of 0.5 to 1.5, and a light permeable area to a light shielding area of the signal line is in a range of 0.5 to 1.5.

Using a same material by the BM and the PS can simplify a CF process flow, but structural changes need to be made so as to apply the BM and the PS to a common electrode contact of a liquid crystal display panel in a VA mode in a liquid crystal panel segment process. A blue resist, a red resist, or a stack of a blue resist and a red resist is disposed on a metal of a second substrate to avoid the light leakage caused by a hollow portion of the light shielding layer, thereby improving an optical density value.

According to this application, in the process flow, costs in the liquid crystal panel process are not additionally added and the risk of light leakage on a rear edge of a module can be effectively prevented.

### BRIEF DESCRIPTION OF THE DRAWINGS

FIG. 1 is a schematic structural diagram of a liquid crystal display panel according to this application; and

FIG. 2 is a schematic structural diagram of a bezel region of the liquid crystal display panel according to this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using same reference numbers. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, a region, and the like are enlarged. In the accompanying drawings, for understanding and ease of description, thicknesses of some layers and regions are enlarged. It should be understood that when a component such as a layer, a film, a region, or a substrate is described to be “on” another component, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that one is located above or below a target component and does not necessarily mean that one is located on the top based on a gravity direction.

To further describe the technical means used in this application to achieve the application objective and effects thereof, specific implementations, structures, features, and effects of a liquid crystal display panel and a liquid crystal display apparatus using same provided according to this application are described in detail below with reference to the drawings and preferred embodiments.

In an embodiment of this application, the color resist includes a body portion and an extension portion. A color resist located in a display region is used to present a plurality of colors. A color resist located in a bezel region is used to prevent the light leakage caused by a hollow portion of the light shielding layer, thereby improving an optical density value.

In an embodiment of this application, a BM and a PS located on a first substrate are integrally formed on the first substrate by using a same material by means of a same process. The light shielding layer is located below a common electrode.

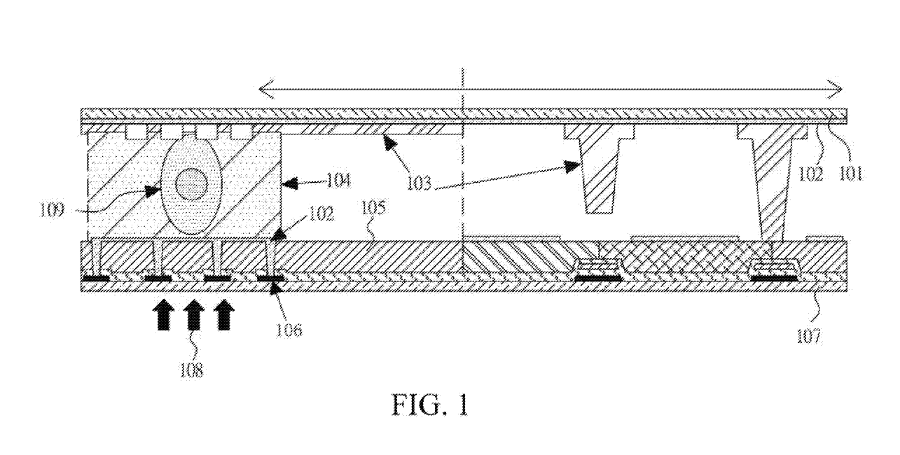

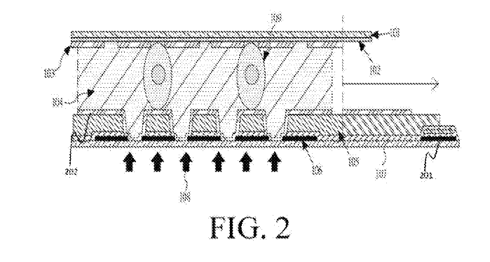

As shown in FIG. 1, FIG. 1 is a schematic diagram of a liquid crystal display panel according to this application. As shown in FIG. 2, FIG. 2 is a specific schematic structural diagram of a bezel region of the liquid crystal display panel according to this application. Referring to both FIG. 1 and FIG. 2, the liquid crystal display panel includes: a first substrate 101 and a second substrate 107. A common electrode 102 is disposed on an inner side of the first substrate 101. A light shielding layer 103 includes a BM and a PS integrally formed on the common electrode 102 by using a same material by means of a same process. A common electrode 102 is disposed on an inner side of the second substrate 107 and is used as a transfer pad in a part of a bezel region. The light shielding layer 103 corresponding to the transfer pad is designed to have an opening in a part of the bezel region, and has a hollow structure. A ratio of a light permeable area to a light shielding area of the light shielding layer 103 is in a range of 0.5 to 1.5.

In an embodiment, the ratio of the light permeable area to the light shielding area may be in a range of 0.7 to 1.1.

The common electrode 102 and the light shielding layer 103 are disposed on the first substrate 101. The light shielding layer 103 is formed on the common electrode 102, and is located on the bezel region of the first substrate 101. The light shielding layer 103 may include an opening to expose the common electrode 102.

The second substrate 107 is disposed opposite to the first substrate 101. The second substrate 107 includes a plurality of active switches 201, a plurality of color resists 105, a transparent electrode 202, and a signal line 106. The plurality of color resists 105 is formed on the active switches 201. The transparent electrode 202 is formed on the plurality of color resists 105 and is electrically connected to the active switches 201. The signal line 106 and some of the plurality of color resists 105 are located on the bezel region of the second substrate 107. The color resists 105 located on the bezel region of the second substrate include through holes to expose the signal line 106, so that the transparent electrode 202 comes into contact with the signal line. A liquid crystal layer is sandwiched between the first substrate 101 and the second substrate 107.

A sealant 104 is formed on the bezel region and is used to stick the first substrate 101 with the second substrate 107 in a sealing manner. A conductive metal ball 109 is disposed in the sealant 104 to electrically connect the common electrode 102 of the first substrate 101 to the transparent electrode 202 of the second substrate 107.

In various embodiments, the signal line 106 may have a hollow structure, and a layout shape of the signal line 106 is in a complementary relationship with an opening layout shape, in the part of the bezel region, of the light shielding layer 103, to prevent light leakage.

In an embodiment, the liquid crystal display panel in this application may be a curved liquid crystal display panel.

The signal line 106 is disposed in the part of the bezel region on the inner side of the second substrate 107 as an electrode contact to be connected to the transfer pad. The signal line 106 is designed to have an opening, and has a hollow structure. The layout shape of the signal line 106 is in a complementary relationship with a layout shape, in the part of the bezel region, of the light shielding layer 103. The ratio of the light permeable area to the light shielding area is in a range of 0.5 to 1.5. The signal line includes a blue resist, a red resist, or a stack of a blue resist and a red resist. The color resists 105 are disposed to prevent the light leakage caused by the opening design, in the part of the bezel region, of the light shielding layer 103 located on the first substrate. A light leakage range is narrowed by stacking the color resists 105 on the transfer pad of the second substrate, to improve an optical density value. The conductive metal ball 109 is located above the color resists of the second substrate, and is located below a hollow portion of the light shielding layer of the first substrate. In addition, ultraviolet light 108 illuminates on a side of the second substrate 107, to cure the sealant 104.

In an embodiment of this application, in the part of the bezel region, the light shielding layer of the first substrate is complementarily combined with a metal part of the second substrate, so as to prevent the light leakage caused by the opening design, in the part of the bezel region, of the light shielding layer, thereby improving the optical density value.

The light shielding layer in this application is used in the part of the bezel region on a periphery of the liquid crystal display panel. Because the layout shape of the signal line is in a complementary relationship with the layout shape, in the part of the bezel region, of the light shielding layer, on one hand, working procedures are simplified in the process and costs are reduced, and on the other hand, the light leakage caused by the hollow portion, in the part of the bezel region, of the light shielding layer is prevented.

In an embodiment of this application, the light shielding layer is in a central annular structure.

In an embodiment of this application, the light shielding layer is in a mesh structure.

In an embodiment of this application, the light shielding layer is in a fan-shaped structure.

In an embodiment of this application, the light shielding layer is in a staggered checkerboard structure.

In an embodiment of this application, the light shielding layer is in a staggered zigzag structure.

In an embodiment of this application, the light shielding layer is in a circular mesh structure.

In an embodiment of this application, the hollow structure of the light shielding layer is a regular light permeable shape, and the ratio of the light permeable area to the light shielding area of the light shielding layer is in a range of 0.5 to 1.5. The design shape of the hollow portion may be determined according to a requirement of a designer, and is not limited.

In this application, the light shielding layer is applied to a process design of an RGB or a WRGB matrix, and particularly, to a liquid crystal display panel in a VA mode. Because the BM and the PS use a same material and a same process, a common electrode process of a CF substrate is adjusted from one in which a BM process is used to one in which no BM process is used. Because the common electrode process of the CF substrate is adjusted on a common electrode contact of an external circuit, correspondingly, structural adjustment needs to be performed on the corresponding transfer pad in the part of the bezel region of the light shielding layer, so as to design the shape, in the part of the bezel region, of the light shielding layer into a regular partially light-permeable shape. Correspondingly, a layout shape of the metal part of the second substrate is in a complementary relationship with the layout shape, in the part of the bezel region, of the light shielding layer. Moreover, to prevent the light leakage, the light leakage range is narrowed by stacking color resists on the transfer pad of the second substrate.

This application further provides a liquid crystal display apparatus. In addition to a backlight module, the liquid crystal display apparatus further includes the liquid crystal display panel according to the foregoing implementation.

The signal line has a hollow structure. A layout shape of the signal line is in a complementary relationship with a layout shape, in a part of a bezel region, of the light shielding layer. A ratio of a light permeable area to a light shielding area of the signal line is in a range of 0.5 to 1.5.

The foregoing embodiments are merely preferred embodiments exemplified to sufficiently describe this application. The protection scope of this application is not limited thereto. All equivalent replacements or transformations made by a person skilled in the art based on this application shall fall within the protection scope of this application. The protection scope of this application is subject to the claims.

What is claimed is:

1. A liquid crystal display panel, comprising:
a first substrate, comprising a common electrode and a light shielding layer, wherein the light shielding layer is formed on the common electrode and is located on a bezel region of the first substrate, and the light shielding layer comprises an opening to expose the common electrode;
a second substrate, disposed opposite to the first substrate, wherein the second substrate comprises a plurality of active switches, a plurality of color resists, a transparent electrode, and a signal line, the plurality of color resists is formed on the active switches, the transparent electrode is formed on the plurality of color resists and is electrically connected to the active switches, the signal line and some of the plurality of color resists are located on a bezel region of the second substrate, and the color resists located on the bezel region of the second substrate comprise through holes to expose the signal line, so that the transparent electrode comes into contact with the signal line;
a liquid crystal layer, sandwiched between the first substrate and the second substrate; and
a sealant, formed on the bezel region and used to stick the first substrate with the second substrate in a sealing manner, wherein the sealant comprises a conductive metal ball to connect the common electrode of the first substrate to the transparent electrode of the second substrate, wherein
the signal line comprises a hollow structure, and a layout shape of the signal line is in a complementary relationship with an opening layout shape, in a part of the bezel region, of the light shielding layer.

2. The liquid crystal display panel according to claim 1, wherein the light shielding layer located on the first substrate is in a hollow structure, and a ratio of a light permeable area to a light shielding area of the light shielding layer is in a range of 0.5 to 1.5.

3. The liquid crystal display panel according to claim 1, wherein the light shielding layer is in a central annular structure.

4. The liquid crystal display panel according to claim 1, wherein the light shielding layer is in a mesh structure.

5. The liquid crystal display panel according to claim 1, wherein the light shielding layer is in a fan-shaped structure.

6. The liquid crystal display panel according to claim 1, wherein the light shielding layer is in a staggered checkerboard structure.

7. The liquid crystal display panel according to claim 1, wherein the light shielding layer is in a staggered zigzag structure.

8. The liquid crystal display panel according to claim 1, wherein the light shielding layer is in a circular mesh structure.

9. The liquid crystal display panel according to claim 1, wherein the signal line comprises a blue resist, a red resist, or a stack of a blue resist and a red resist.

10. The liquid crystal display panel according to claim 1, wherein a ratio of a light permeable area to a light shielding area of the signal line is in a range of 0.5 to 1.5.

11. A liquid crystal display apparatus, comprising:
a backlight module; and
a liquid crystal display panel, comprising:
a first substrate, comprising a common electrode and a light shielding layer, wherein the light shielding layer is formed on the common electrode and is located on a bezel region of the first substrate, and the light shielding layer comprises an opening to expose the common electrode;
a second substrate, disposed opposite to the first substrate, wherein the second substrate comprises a plurality of active switches, a plurality of color resists, a transparent electrode, and a signal line, the plurality of color resists is formed on the active switches, the transparent electrode is formed on the plurality of color resists and is electrically connected to the active switches, the signal line and some of the plurality of color resists are located on a bezel region of the second substrate, and the color resists located on the bezel region of the second substrate comprise through holes to expose the signal line, so that the transparent electrode comes into contact with the signal line;
a liquid crystal layer, sandwiched between the first substrate and the second substrate; and
a sealant, formed on the bezel region and used to stick the first substrate with the second substrate in a sealing manner, wherein the sealant comprises a conductive metal ball to connect the common electrode of the first substrate to the transparent electrode of the second substrate, wherein
the signal line comprises a hollow structure, and a layout shape of the signal line is in a complementary relationship with an opening layout shape, in a part of the bezel region, of the light shielding layer.

12. The liquid crystal display apparatus according to claim 11, wherein the light shielding layer located on the first substrate is in a hollow structure, and a ratio of a light permeable area to a light shielding area of the light shielding layer is in a range of 0.5 to 1.5.

13. The liquid crystal display apparatus according to claim 11, wherein the light shielding layer is in a central annular structure.

14. The liquid crystal display apparatus according to claim 11, wherein the light shielding layer is in a mesh structure or a fan-shaped structure.

15. The liquid crystal display apparatus according to claim 11, wherein the light shielding layer is in a staggered checkerboard structure.

16. The liquid crystal display apparatus according to claim 11, wherein the light shielding layer is in a staggered zigzag structure.

17. The liquid crystal display apparatus according to claim 11, wherein the light shielding layer is in a circular mesh structure.

18. The liquid crystal display apparatus according to claim 11, wherein the signal line comprises a blue resist, a red resist, or a stack of a blue resist and a red resist.

19. The liquid crystal display apparatus according to claim 11, wherein a ratio of a light permeable area to a light shielding area of the signal line is in a range of 0.5 to 1.5.

20. A liquid crystal display panel, comprising:
a first substrate, comprising a common electrode and a light shielding layer, wherein the light shielding layer is formed on the common electrode and is located on a bezel region of the first substrate, and the light shielding layer comprises an opening to expose the common electrode;
a second substrate, disposed opposite to the first substrate, wherein the second substrate comprises a plurality of active switches, a plurality of color resists, a transparent electrode, and a signal line, the plurality of color resists is formed on the active switches, the transparent electrode is formed on the plurality of color resists and is electrically connected to the active switches, the signal line and some of the plurality of color resists are located on a bezel region of the second substrate, and the color resists located on the bezel region of the second substrate comprise through holes to expose the signal line, so that the transparent electrode comes into contact with the signal line;
a liquid crystal layer, sandwiched between the first substrate and the second substrate; and
a sealant, formed on the bezel region and used to stick the first substrate with the second substrate in a sealing manner, wherein the sealant comprises a conductive metal ball to connect the common electrode of the first substrate to the transparent electrode of the second substrate, wherein
the signal line comprises a hollow structure, and a layout shape of the signal line is in a complementary relationship with an opening layout shape, in a part of the bezel region, of the light shielding layer; and
the light shielding layer located on the first substrate is in a hollow structure, a ratio of a light permeable area to a light shielding area of the light shielding layer is in a range of 0.5 to 1.5, and a light permeable area to a light shielding area of the signal line is in a range of 0.5 to 1.5.
